(19) United States
(12) Patent Application Publication
(10) Pub. No.: US 2026/0087614 A1
(43) Pub. Date: Mar. 26, 2026

(54) APPARATUS AND METHOD FOR ALIGNING ELECTRODE

(71) Applicant: SK On Co., Ltd., Seoul (KR)

(72) Inventors: Soo Yeon PARK, Daejeon (KR); Ji Won YANG, Daejeon (KR); Jeong Seob LEE, Daejeon (KR)

(21) Appl. No.: 19/328,245

(22) Filed: Sep. 15, 2025

(30) Foreign Application Priority Data
Sep. 25, 2024 (KR) 10-2024-0129899
Jan. 14, 2025 (KR) 10-2025-0005460

(51) Int. Cl. G06T 7/00; G06T 7/73

(52) U.S. Cl. CPC G06T 7/001; G06T 7/74; G06T 2207/30108

(57) ABSTRACT

Proposed is an apparatus for aligning an electrode, wherein the apparatus comprises an electrode transfer device configured to transfer a plurality of electrodes, a first imaging device configured to obtain a first image by capturing an image of an electrode on the electrode transfer device, an alignment stage having a top surface on which the electrode transferred from the electrode transfer device is seated, the alignment stage being movable, a first pickup device configured to transfer the electrode from the electrode transfer device to the alignment stage, and a controller configured to perform a pre-movement of the alignment stage such that the alignment stage corresponds to a position of the electrode shown in the first image before the electrode is seated on the alignment stage.

### CROSS REFERENCE TO RELATED APPLICATION

The present application claims priority to Korean Patent Application No. 10-2024-0129899, filed Sep. 25, 2024, and Korean Patent Application No. 10-2025-0005460, filed Jan. 14, 2025, the entire contents of which are incorporated herein for all purposes by this reference.

### TECHNICAL FIELD

The present disclosure relates to an apparatus and a method for aligning an electrode.

### BACKGROUND

A secondary battery is defined as a battery configured to be charged and discharged, and may be applied to various devices, comprising, for example, smartphones, electric vehicles, and energy storage systems. The secondary battery may comprise a positive electrode, a separator, and a negative electrode that are sequentially stacked, accommodated within a case, and filled with an electrolyte. In a process of manufacturing a battery cell, a stacking process of the positive electrode, the separator, and the negative electrode may be performed, and prior to performing the stacking process, the positive electrode and the negative electrode may be aligned in predetermined directions. When the positive electrode and the negative electrode are not properly aligned, defects may occur in the battery cell.

The foregoing is intended merely to aid in the understanding of the background of the present disclosure, and is not intended to mean that the present disclosure falls within the scope of the related art that is already known to those skilled in the art.

### SUMMARY

According to an aspect of the present disclosure, there is provided an apparatus and method for aligning an electrode, in which a position of an electrode is measured prior to transferring the electrode to an alignment stage, the alignment stage is moved to correspond to the position of the electrode, and the electrode is then transferred to the alignment stage.

According to another aspect of the present disclosure, there is provided an apparatus and method for aligning an electrode, in which a portion of the alignment stage is made of a transparent material to allow a vertex of the electrode to be captured by a camera.

According to still another aspect of the present disclosure, there is provided an apparatus and method for aligning an electrode, in which suction holes for securing an electrode placed on the alignment stage are disposed adjacent to an edge of the electrode.

The apparatus and method for aligning an electrode according to an aspect of the present disclosure may be applied to a manufacturing process of batteries that are widely used in green technology fields such as electric vehicles, battery charging stations, solar power generation, and wind power generation.

The apparatus and method for aligning an electrode according to an aspect of the present disclosure may also be applied to a manufacturing process of batteries used in eco-friendly electric vehicles (EVs) and hybrid vehicles (HVs), which are intended to suppress air pollution and greenhouse gas emissions in order to prevent climate change.

According to an aspect of the present disclosure, an apparatus for aligning an electrode may be provided, the apparatus comprising: an electrode transfer device configured to transfer a plurality of electrodes; a first imaging device configured to obtain a first image by capturing an image of the electrode on the electrode transfer device; an alignment stage having a top surface on which the electrode transferred from the electrode transfer device is seated, the alignment stage being movable; a first pickup device configured to transfer the electrode from the electrode transfer device to the alignment stage; and a controller configured to perform a pre-movement of the alignment stage such that the alignment stage corresponds to a position of the electrode shown in the first image before the electrode is seated on the alignment stage.

According to an embodiment, when the position of the electrode shown in the first image exceeds a preset alignable range relative to a reference position, the controller may determine that the electrode is defective and generate a removal command.

According to an embodiment, the apparatus for aligning an electrode may further comprise a second imaging device configured to obtain a second image by capturing the image of the electrode seated on a pre-moved alignment stage, wherein the controller may perform an alignment movement to transfer the alignment stage such that the position of the electrode shown in the second image is aligned with the reference position.

According to an embodiment, the second imaging device may be configured to obtain a third image by capturing the image of the electrode seated on the pre-moved alignment stage, and the controller may further perform the alignment movement to transfer the alignment stage such that the position of the electrode shown in the third image is aligned with the reference position.

According to an embodiment, the alignment stage may comprise: an opaque region made of an opaque material; and a transparent region made of a transparent material to allow observation of the electrode seated on the top surface from a bottom surface, wherein the second imaging device may capture the image of the electrode through the transparent region in the direction from the bottom surface, opposite to the top surface on which the electrode of the alignment stage is seated.

According to an embodiment, the controller may move a region of interest for detecting the position of the electrode in the second image according to a movement of the alignment stage shown in the second image in accordance with the movement of the alignment stage and detect the position of the electrode.

According to an embodiment, the alignment stage may comprise a plurality of fixing portions disposed along an edge where the electrode is to be seated and configured to secure the electrode.

According to an embodiment, a method for aligning an electrode may be provided, the method comprising: transferring a plurality of electrodes using an electrode transfer device; obtaining a first image using a first imaging device that captures an image of the electrode on the electrode transfer device; performing a pre-movement by transferring an alignment stage with a controller to correspond to a position of the electrode in the first image; and transferring the electrode from the electrode transfer device to the alignment stage using a first pickup device.

According to an embodiment, the method may further comprise: determining that the electrode is defective and generating a removal command in response to the controller determining that the position of the electrode on the electrode transfer device exceeds a preset alignable range relative to a reference position.

According to an embodiment, the method for aligning an electrode may further comprise: obtaining, by a second imaging device, a second image by capturing the image of the electrode seated on a pre-moved alignment stage; and performing an alignment movement to transfer the alignment stage, by the controller, such that the position of the electrode shown in the second image is aligned with the reference position.

According to an embodiment, the method may further comprise: obtaining, by the second imaging device, a third image by capturing the image of the electrode on the alignment stage that has been alignment-moved; and performing a realignment movement, by the controller, to transfer the alignment stage such that the position of the electrode shown in the third image is aligned with the reference position.

According to an embodiment, the alignment stage may comprise: an opaque region made of an opaque material; and a transparent region made of a transparent material to allow observation of the electrode seated on a top surface from a bottom surface, wherein the obtaining the second image may comprise capturing, by the second imaging device, the image of the electrode through the transparent region in the direction from the bottom surface, opposite to the top surface on which the electrode of the alignment stage is seated.

According to an embodiment, the performing the alignment movement may comprise performing the alignment movement such that the controller moves a region of interest in accordance with a movement of the alignment stage to detect the position of the electrode shown in the second image, determines the position of the electrode, and transfers the alignment stage such that the position of the electrode shown in the second image is aligned with the reference position.

According to an embodiment, the method may further comprise fixing the electrode seated on the alignment stage using a plurality of fixing portions disposed along an edge of the alignment stage where the electrode is seated.

As described above, according to an embodiment of the present disclosure, the position of an electrode may be measured in advance by the electrode transfer device, and by pre-moving the alignment stage, the operating range and alignment time required to align the electrode may be reduced.

According to another embodiment of the present disclosure, the position of an electrode may be measured in advance by the electrode transfer device, and electrodes that fall outside an alignable range from a reference position may be removed before being transferred to the alignment stage, thereby eliminating unnecessary alignment attempts for electrodes that may not be aligned.

According to an embodiment of the present disclosure, the surface of the electrode placed on the alignment stage may be secured and the position of the electrode may be accurately measured without the measurement error caused by the curling generated at the edge of the electrode.

According to an embodiment of the present disclosure, the surface of an electrode settled on an alignment stage can be evenly adsorbed, and the position of the electrode can be accurately measured without measurement errors caused by curls generated at the electrode edge.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates an apparatus for aligning an electrode according to an embodiment of the present disclosure;

FIG. 2 illustrates a state in which electrodes have been transferred by an electrode transfer device according to an embodiment of the present disclosure;

FIG. 3 illustrates a state in which an alignment stage has been pre-moved according to an embodiment of the present disclosure;

FIG. 4 illustrates a state in which an electrode has been transferred from the electrode transfer device to the pre-moved alignment stage according to an embodiment of the present disclosure;

FIG. 5 illustrates a state in which an image of an electrode on the pre-moved alignment stage is captured according to an embodiment of the present disclosure;

FIG. 6 illustrates a state in which the alignment stage has been alignment-moved according to an embodiment of the present disclosure;

FIG. 7 illustrates a state in which an image of an electrode on the alignment-moved stage is captured according to an embodiment of the present disclosure;

FIG. 8 illustrates a state in which the alignment stage has been re-aligned according to an embodiment of the present disclosure;

FIG. 9 illustrates a state in which an electrode is aligned on the alignment stage, and no electrode is present in the stacker, according to an embodiment of the present disclosure;

FIG. 10 illustrates a state in which an electrode has been transferred from the alignment stage to the stacker, according to an embodiment of the present disclosure;

FIG. 11 illustrates a transparent region and a fixing portion of the alignment stage according to an embodiment of the present disclosure;

FIG. 12 is a cross-sectional view taken along line A-A′ of FIG. 11, illustrating a second imaging device;

FIG. 13 illustrates an electrode and the alignment stage, as viewed from C1 of FIG. 12;

FIG. 14 illustrates an electrode and the alignment stage, as viewed from C2 of FIG. 12;

FIG. 15 illustrates a position of a region of interest in an image of the alignment stage before pre-movement according to an embodiment of the present disclosure;

FIG. 16 illustrates a position of a region of interest in an image of the alignment stage after pre-movement according to an embodiment of the present disclosure;

FIG. 17 illustrates a position of a region of interest in an image of an electrode seated on the alignment stage after pre-movement according to an embodiment of the present disclosure;

FIG. 18 illustrates a position of a region of interest in an image of the electrode on the alignment stage after alignment movement, according to an embodiment of the present disclosure;

FIG. 19 illustrates the function of the fixing portion according to an embodiment of the present disclosure;

FIG. 20 illustrates a relationship between the position of the fixing portion and the electrode in a comparative example; and

FIG. 21 illustrates an electrode alignment method according to an embodiment of the present disclosure.

### DETAILED DESCRIPTION

Hereinafter, the present disclosure will be described in detail with reference to the accompanying drawings. However, the embodiments described herein are merely exemplary, and the present disclosure is not limited thereto.

In the following, an embodiment of the present disclosure is described below with reference to the accompanying drawings.

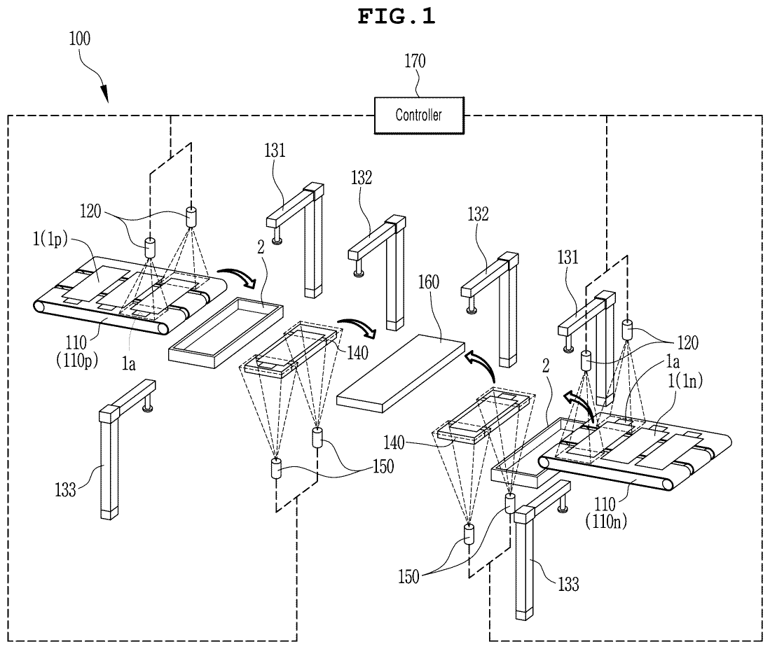

FIG. 1 illustrates an apparatus 100 for aligning an electrode according to an embodiment of the present disclosure.

The apparatus 100 for aligning an electrode according to an embodiment may comprise: an electrode transfer device 110 configured to transfer a plurality of electrodes 1; a first imaging device 120 configured to capture a first image Im1 by capturing an image of an electrode 1 on the electrode transfer device 110; an alignment stage 140 having a top surface on which an electrode 1 conveyed from the electrode transfer device 110 is seated and being movable; a first pickup device 131 configured to transfer the electrode 1 from the electrode transfer device 110 to the alignment stage 140; and a controller 170 configured to perform a pre-alignment movement to move the alignment stage 140 such that the alignment stage corresponds to a position of the electrode 1 shown in the first image Im1 before the electrode 1 is seated on the alignment stage 140.

The apparatus 100 is configured to align the electrode 1 to a predetermined position before supplying the electrode 1 to a stacker 160. The apparatus 100 for aligning an electrode may align the electrode 1 seated on the alignment stage 140 to a reference position. The electrode 1 may be a positive electrode 1p or a negative electrode 1n. The electrode 1 may have a structure in which a mixture layer is coated on a current collector and a tab 1a is formed on one side of the current collector. The electrode 1 may be transferred from an electrode manufacturing device or an electrode storage device to the electrode transfer device 110. The electrode 1 may be conveyed toward the alignment stage 140 by the electrode transfer device 110. The electrode manufacturing device may comprise one or more devices configured to perform coating, drying, notching, or cutting processes. The electrode storage device may comprise a device, such as a magazine, for storing a plurality of the electrodes 1.

The electrode transfer device 110 may be configured to transfer a plurality of electrodes 1, and may comprise, for example, a conveyor belt or a linear motion system (LMS). The electrode transfer device 110 may convey electrodes 1 toward the alignment stage 140. The electrode transfer device 110 may comprise a positive electrode transfer device 110p for conveying positive electrodes 1p, and a negative electrode transfer device 110n for conveying negative electrodes 1n.

The first imaging device 120 may be configured to capture an image of an electrode 1 conveyed on the electrode transfer device 110 to generate the first image Im1. The first imaging device 120 may comprise a camera as an image capturing device. The first imaging device 120 may provide the first image Im1 to the controller 170. The first imaging device 120 may be positioned above the electrode transfer device 110 to capture a top surface thereof. A plurality of first imaging devices 120 may be provided. For example, of two first imaging devices 120, one may capture an image of a portion of the electrode 1 having the tab 1a, and the other may capture an image of a portion of the electrode 1 without the tab 1a. Two first imaging devices 120 may capture an image of the positive electrode 1p, and another two first imaging devices 120 may capture an image of the negative electrode 1n.

The alignment stage 140 may align the position of the electrode 1 to a reference position. The reference position refers to a position on the alignment stage 140 at which the electrode 1 is to be aligned before being supplied to the stacker 160. The alignment stage 140 may comprise a plate on one surface for seating the electrode 1 and may have a size larger than the electrode 1. The alignment stage 140 may move in an X-axis direction and a Y-axis direction of the surface on which the electrode 1 is seated, and may rotate about a T-axis perpendicular to the seating surface. The alignment stage 140 may clockwise or counterclockwise direction. The alignment stage 140 may be controlled according to an (X, Y, T) scheme or a (U, V, W) scheme. The alignment stage 140 may be driven by a motor, gears, shafts, electromagnetic force, or other control mechanisms. Various configurations for transferring the alignment stage 140 may be employed, but are omitted from the drawings for clarity.

The first pickup device 131 may transfer an electrode 1 from the electrode transfer device 110 to the alignment stage 140. A second pickup device 132 may transfer the electrode 1 from the alignment stage 140 to the stacker 160. The first pickup device 131 and the second pickup device 132 may be pick-and-place devices. The first pickup device 131 and the second pickup device 132 may comprise a holder for securing the electrode 1 or a gripper for gripping the electrode 1, and may further comprise a robot arm or a moving frame for transferring the holder or gripper. The first pickup device 131 may pick up the electrode 1 from the electrode transfer device 110, transfer it onto the alignment stage 140, and release it in a correct position. The first pickup device 131 and the second pickup device 132 may be implemented as a single pickup device. In this case, the single pickup device may transfer electrode 1 from the electrode transfer device 110 to the alignment stage 140, and then from the alignment stage 140 to the stacker 160.

The controller 170 may receive the first image Im1 from the first imaging device 120. The controller 170 may control movement of the alignment stage 140 to align the electrode 1. The controller 170 may control the first pickup device 131 in order to transfer the electrode 1 from the electrode transfer device 110 to the alignment stage 140.

The controller 170 may comprise a processor and a storage operatively connected to the processor. The storage may comprise a volatile or non-volatile memory, a hard disk drive, a solid-state drive, or an optical storage medium, and may store program code for executing steps of the electrode alignment method. The storage may further store data or commands necessary for performing the electrode alignment method. The processor may execute the program code stored in the storage to perform the electrode alignment method. The controller 170 may further comprise an input/output interface having output devices, such as a display or speaker, for providing data or alignment results visually or audibly to a user, and input devices, such as a touchpad, keyboard, buttons, or mouse, which receive data or commands from the user. The controller 170 may further comprise a communication interface configured to transmit and receive data or commands with a secondary battery manufacturing process control system, a PLC, or a computer device. The communication interface may comprise circuits, communication chips, or antennas for using wired network methods such as IPv4, IPv6, Ethernet, LAN, or WAN, or wireless network methods such as 5G, 6G, Wi-Fi, or Bluetooth.

The controller 170 may analyze the first image Im1 to obtain the position of the electrode 1. The first imaging device 120 may be positioned at a predetermined position above the electrode transfer device 110 to capture a predetermined region thereof. The first image Im1 may comprise an image of the electrode 1 on the electrode transfer device 110. Details of how the controller 170 recognizes the position of the electrode 1 in the first image Im1 are described below.

The controller 170 may perform a pre-alignment movement before the electrode 1 is seated on the alignment stage 140. The pre-alignment movement refers to position the alignment stage 140 at a position corresponding to the position of the electrode 1 appearing in the first image Im1. Details of how the controller 170 moves the alignment stage 140 for the pre-alignment movement are described below.

When the position of the electrode 1 appearing in the first image Im1 exceeds a preset alignable range relative to the reference position, the controller 170 may determine that the electrode 1 is defective and generate a removal command. The removal command may be delivered to the pickup devices 131, 132, and 133 or the electrode transfer device 110.

Since the movement range of the alignment stage 140 may be limited, or excessive alignment time could delay the battery cell manufacturing process, the controller 170 may preset the alignable range and treat electrodes 1 whose positions deviate from the alignable range as defective.

In response to the removal command output by the controller 170, the pickup devices 131, 132, and 133 may remove electrodes 1 that deviate from the alignable range from the production line. Various methods may be employed to remove electrodes 1 that deviate from the alignable range or fail to be aligned using the pickup devices 131, 132, and 133.

For example, the first pickup device 131 may pick up an electrode 1 that deviates from the alignable range and transfer it to a defective-electrode collection location.

Alternatively, the first pickup device 131 may pick up the electrode 1 that deviates from the alignable range, place it on the alignment stage 140, and the controller 170 may skip measurement using the second imaging devices 150. The second pickup device 132 may then pick up the electrode 1 that deviates from the alignable range and is positioned on the alignment stage 140, and transfer it to the defective-electrode collection location.

Alternatively, the first pickup device 131 may not pick up the electrode 1 deviating from the alignable range, and the electrode transfer device 110 may convey the electrodes 1 according to a predetermined operation. An electrode 1 not picked up from the electrode transfer device 110 may drop off at the end of the conveyor and enter a box 2 serving as a defective-electrode collection location.

Alternatively, the apparatus 100 for aligning an electrode may further comprise a third pickup device 133 configured to pick up an electrode 1 that deviates from the alignable range from the electrode transfer device 110 and transfer it to the defective-electrode collection location. The third pickup device 133 may also pick up an electrode 1 that has undergone both an alignment operation and a re-alignment operation on the alignment stage 140 but still fails to be aligned, and transfer it to the defective-electrode collection location. The defective-electrode collection location may be the box 2 described above or another box located at a different location.

Alternatively, the first pickup device 131 may pick up the electrode 1 that deviates from the alignable range and place it on the alignment stage 140. Then, without performing measurement using the second imaging devices 150, the third pickup device 133 may pick up the electrode 1 from the alignment stage 140 and transfer it to the defective-electrode collection location.

Since an electrode 1 that deviates from a predetermined range (for example, ±00 mm) from the reference position is treated as defective and removed before being conveyed to the alignment stage 140, the time for defective-product processing may be reduced. Removing electrodes 1 that deviate from the alignable range before supplying them to the alignment stage 140 enables defective electrodes 1 to be discharged more quickly compared to removing electrodes 1 after attempting alignment on the alignment stage 140 and determining them unalignable. Furthermore, since only electrodes 1 within the alignable range are conveyed to the alignment stage 140, the distance by which the electrode 1 deviates from the reference position is reduced. This, in turn, reduces both the time required to detect the boundary 1b of the electrode 1 within the inspection region and the movement distance of the alignment stage 140 to perform alignment movement, thereby enabling alignment in a shorter time. Accordingly, the total battery cell manufacturing time may be reduced.

Since only electrodes 1 within the alignable range are supplied to the alignment stage 140, the deviation between the reference position and the electrode 1 position may be relatively small. Therefore, the distance that the alignment stage 140 needs to move for alignment may be reduced, and the time required for the alignment stage 140 to align the electrode 1 may also be reduced.

When it is difficult to directly convey the electrode 1 on the electrode transfer device 110 to the defective-electrode discharge location, the controller 170 may control the first pickup device 131 to transfer the electrode 1 from the electrode transfer device 110 to the alignment stage 140, and control the second pickup device 132 to discharge the electrode 1 from the alignment stage 140 to the defective-electrode discharge location. In such a case, the controller 170 may omit the pre-alignment movement or the alignment movement of the alignment stage 140. That is, an electrode 1 that deviates from the alignable range may be conveyed from the electrode transfer device 110 to the alignment stage 140 and immediately discharged from the alignment stage 140 to the defective-electrode collection location.

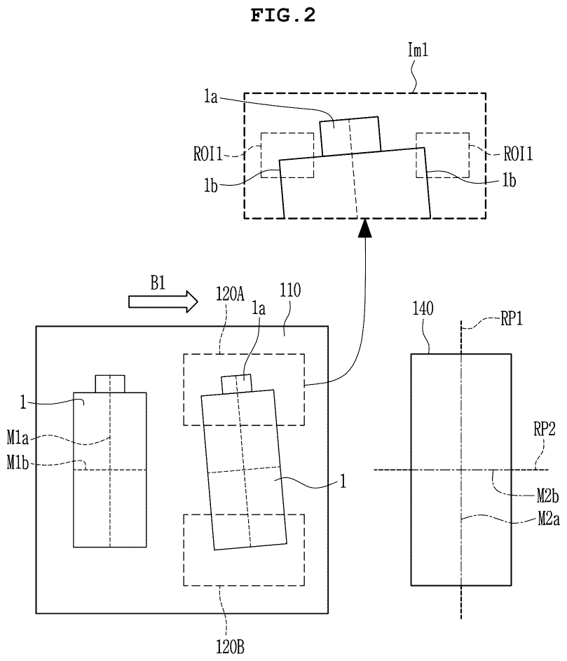

With reference to FIGS. 2 to 8, the alignment of the electrode 1 will be described.

FIG. 2 illustrates a state in which electrodes 1 have been transferred by an electrode transfer device 110 according to an embodiment of the present disclosure. FIGS. 1 and 2 are referred to together. FIGS. 2 to 8 illustrate a top view of the electrode transfer device 110 and the alignment stage 140 as seen from above.

Reference positions RP1 and RP2 may comprise a longitudinal reference line RP1 and a lateral reference line RP2. The longitudinal reference line RP1 and the lateral reference line RP2 are indicated by thick dotted lines, and a center point at which the longitudinal reference line RP1 and the lateral reference line RP2 intersect is shown covered by the alignment stage 140.

A longitudinal center line M2a and a lateral center line M2b of the alignment stage 140 are indicated on the alignment stage 140 as alternate long-and-short dash lines. The position of the alignment stage 140 may be defined by the location of the center point where the longitudinal center line M2a and the lateral center line M2b intersect, and by the angle by which the alignment stage 140 is rotated with respect to the reference positions RP1 and RP2.

A longitudinal center line M1a and a lateral center line M1b of the electrode 1 are indicated on the electrode 1 as thin dotted lines. The position of the electrode 1 may be defined by the location of the center point at which the longitudinal center line M1a and the lateral center line M1b intersect, and by the angle at which the electrode 1 is rotated with respect to the reference positions RP1 and RP2.

When the electrode transfer device 110 performs step S10 of transferring a plurality of electrodes 1, the electrodes 1 may be stopped at a predetermined position on the electrode transfer device 110, as illustrated in FIG. 2. The electrode transfer device 110 may transfer the plurality of electrodes 1 in a spaced-apart state in the direction of arrow B1, and may stop the transfer when one of the electrodes 1 reaches the predetermined position. The predetermined position on the electrode transfer device 110 may correspond to a pickup position at which the first pickup device 131 performs a pickup operation, or to a location corresponding to an area where the first imaging device 120 captures an image of the electrode 1.

When the transfer of the electrode transfer device 110 is temporarily stopped, the first imaging device 120 may capture an image of the electrode 1 on the electrode transfer device 110 to obtain a first image Im1 in step S20. The first imaging device 120 may generate the first image Im1 by capturing the electrode 1 on the electrode transfer device 110, and may transmit the first image Im1 to a controller 170. Two first imaging devices 120 may each generate the first image Im1 and provide it to the controller 170. One of the first imaging devices 120 may capture an image of a first imaging region A 120A on the electrode transfer device 110, as illustrated in FIG. 2. The first imaging region A 120A may comprise a portion of the electrode 1 in which a tab 1a is present. Accordingly, the first imaging device 120 may obtain the first image Im1 including the tab 1a, as shown in the enlarged view of FIG. 2. The other first imaging device 120 may capture an image of a first imaging region B 120B on the electrode transfer device 110, as illustrated in FIG. 2. The first imaging region B 120B may comprise a portion of the electrode 1 in which the tab 1a is absent. Accordingly, the first imaging device 120 may obtain a first image (not shown) in which the tab 1a is not present.

The controller 170 may detect boundaries 1b of an electrode 1 appearing in the first image Im1. At least one first region of interest ROI1 may be set at a predetermined location in the first image Im1, and the coordinate of the boundary 1b of the electrode 1 crossing the first region of interest ROI1 may be determined. The first region of interest ROI1 may be located at a predetermined position in the first image Im1. Once a coordinate of the boundary 1b of the electrode 1 is acquired, the longitudinal center line M1a and the lateral center line M1b of the electrode 1 may be calculated using the width and length of the electrode 1. The controller 170 may recognize, as the position of the electrode 1, coordinates of a center point at which the center lines M1a and M1b of the electrode 1 on the electrode transfer device 110 intersect, and an angle at which the center lines M1a and M1b are inclined with respect to the reference positions RP1 and RP2.

During measurement of the position of an electrode 1 on the electrode transfer device 110, the alignment stage 140 may be maintained at the position where the previous electrode 1 was aligned.

After recognizing the position of the electrode 1, the controller 170 may perform step S30 of determining the electrode 1 as defective and outputting a removal command when it is determined, with reference to FIG. 1, that the electrode 1 is outside the alignable range.

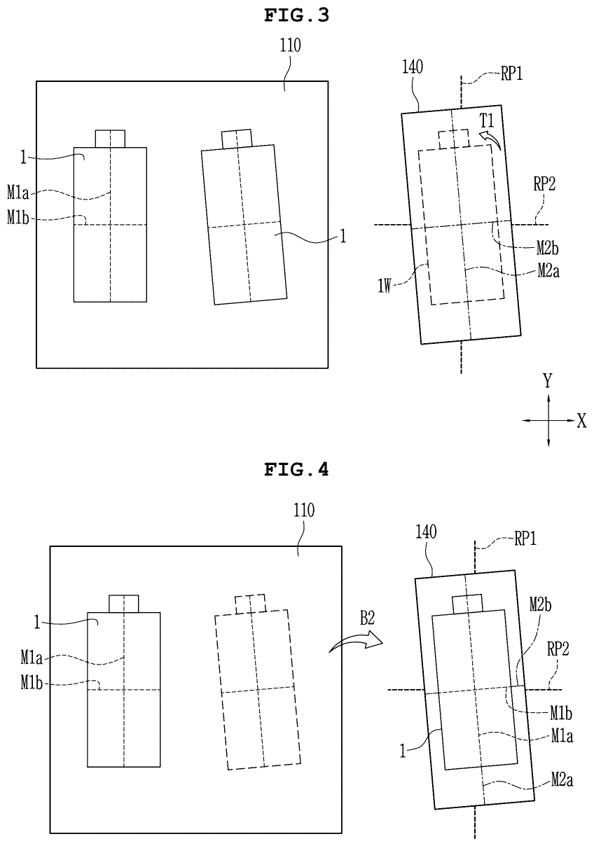

FIG. 3 illustrates a state in which an alignment stage 140 has been pre-moved according to an embodiment of the present disclosure.

By obtaining the position of an electrode 1 using the first image Im1, the controller 170 may perform step S40 of performing a pre-movement, transferring the alignment stage 140 to correspond to the position of the electrode 1 shown in the first image Im1.

When the position of an electrode 1 shown in the first image Im1 is identified, the alignment stage 140 may be pre-moved so that the position of the alignment stage 140 corresponds to the position of the electrode 1 before the electrode 1 is transferred onto the alignment stage 140. Here, the position of the electrode 1 may refer to the position (see the electrode 1W indicated by dashed lines) at which the electrode 1 would be seated on the alignment stage 140 when transferred thereto. When the position of the electrode 1 differs from the reference positions RP1 and RP2, pre-moving the alignment stage 140 to correspond to the position of the electrode 1 allows the positions of the electrode 1 and the alignment stage 140 to correspond when the electrode 1 is transferred onto the alignment stage 140. That is, the center lines M2a and M2b of the alignment stage 140 and the center lines M1a and M1b of the electrode 1 to be transferred by the first pickup device 131 may be aligned.

In the pre-moved state, the center lines M2a and M2b of the alignment stage 140 may differ from the reference position RP1 and RP2 because the alignment stage 140 has been moved to correspond to the positions of an electrode 1. In the pre-movement, the alignment stage 140 may be rotated in the rotational direction of the electrode 1, or moved by an amount corresponding to the offset of the electrode 1 in the X-axis or Y-axis direction. For example, as shown in FIG. 3, when the electrode 1 is rotated counterclockwise, the alignment stage 140 may also be rotated counterclockwise (see arrow T1).

FIG. 4 illustrates a state in which an electrode 1 has been transferred from the electrode transfer device 110 to the pre-moved alignment stage 140 according to an embodiment of the present disclosure.

When the pre-movement is completed, the first pickup device 131 may perform step S50, in which an electrode 1 on the electrode transfer device 110 is transferred to the alignment stage 140. After performing the pre-movement, the controller 170 may control the first pickup device 131 to transfer the electrode 1 to the alignment stage 140 (see arrow B2). The first pickup device 131 may pick up the electrode 1 from the electrode transfer device 110 as is, move it to the alignment stage 140 while maintaining the pickup state, and then release it to place the electrode 1 on the alignment stage 140. When the first pickup device 131 transfers the electrode 1, the electrode 1 may be positioned on the alignment stage 140 in the same misaligned state as on the electrode transfer device 110, as shown in FIG. 4. As a result, the center lines M1a and M1b of the electrode 1 and the center lines M2a and M2b of the alignment stage 140 may coincide. Although the process of picking up and releasing the electrode 1 by the first pickup device 131 may cause a slight misalignment between the center lines M1a and M1b of the electrode 1 and the center lines M2a and M2b of the alignment stage 140, the degree of misalignment may be very small because the alignment stage 140 has already been pre-moved to correspond to the transfer position of the electrode 1.

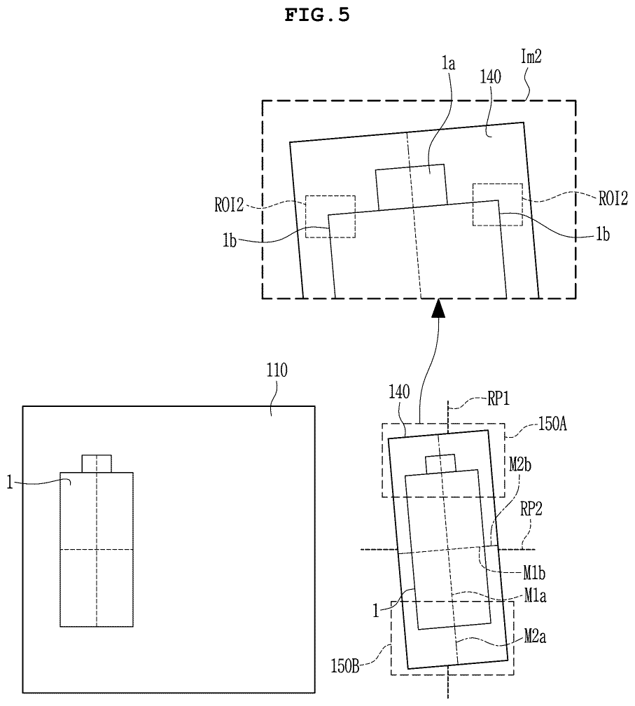

FIG. 5 illustrates a state in which an image of an electrode 1 on the pre-moved alignment stage 140 is captured according to an embodiment of the present disclosure.

After the electrode 1 is transferred from an electrode feeder to the alignment stage 140, step S70 may be performed, in which a second image Im2 of the electrode 1 seated on the pre-moved alignment stage 140 is captured by a second imaging device 150. The apparatus 100 for aligning an electrode may further comprise the second imaging device 150 configured to capture the second image Im2 of the electrode 1 seated on the pre-moved alignment stage 140.

The second imaging device 150 may generate the image in a manner similar to the first imaging device 120 by capturing an image of the electrode 1. The second imaging device 150 may comprise a camera and may capture an image of the electrode 1 seated on the alignment stage 140 to generate the second image Im2. A plurality of second imaging devices 150 may be provided. For example, one of the two second imaging devices 150 may capture an image of a second imaging region A 150A of the alignment stage 140, which comprises a portion of the electrode 1 where the tab 1a is present. The other second imaging device 150 may capture an image of a second imaging region B 150B of the alignment stage 140, which may comprise a portion of the electrode 1 where the tab 1a is absent. A second image Im2 obtained by capturing the second imaging region A 150A is shown in the enlarged view of FIG. 5. The second imaging device 150 may provide the second image Im2 to the controller 170.

As shown in FIG. 1, the second imaging device 150 may be located below the alignment stage 140 to capture an image of a bottom surface 140b of the alignment stage 140. To enable the second imaging device 150 to capture an image of the electrode 1 located on the top surface of the alignment stage 140 from below, at least a portion of the alignment stage 140 may be made of a transparent material. A region of the alignment stage 140 made of the transparent material will be described later.

Alternatively, instead of the position of the second imaging device 150 shown in FIG. 1, the second imaging device 150 may be located above the alignment stage 140 to capture an image of the top surface 140a of the alignment stage 140 on which the electrode 1 is seated. The enlarged view in FIG. 5 illustrates the second image Im2 obtained with the second imaging device 150 positioned to capture an image of the top surface 140a of the alignment stage 140.

The controller 170 may analyze the second image Im2 received from the second imaging device 150 to recognize the position of the electrode 1. The controller 170 may detect a boundary 1b of the electrode 1 appearing in the second image Im2. At least one second region of interest ROI2 may be set at a predetermined location in the second image Im2, and a coordinate of the boundary 1b of the electrode 1 within the second region of interest ROI2 may be determined. The second region of interest ROI2 may be located at a predetermined position in the second image Im2. Details regarding the location of the second region of interest ROI2 will be described later. Once a coordinate of the boundary 1b of the electrode 1 is acquired, the longitudinal center line M1a and the lateral center line M1b of the electrode 1 may be calculated on the basis of a width and a length of the electrode 1. The controller 170 may recognize, as the position of the electrode 1, the coordinates of a center point at which the center lines M1a and M1b of the electrode 1 on the alignment stage 140 intersect, and an inclination angle of the center lines M1a and M1b with respect to reference positions RP1 and RP2. More details regarding the recognition of the position of the electrode 1 in the second image Im2 by the controller 170 will be described later.

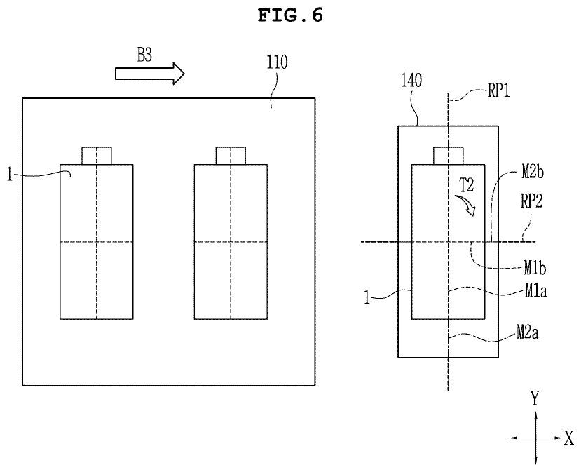

FIG. 6 illustrates a state in which the alignment stage 140 has been alignment-moved according to an embodiment.

When the controller 170 obtains the position of the electrode 1 on the alignment stage 140, the controller 170 may perform an alignment movement step S80 of transferring the alignment stage 140 such that the position of the electrode 1 shown in the second image Im2 is aligned with a reference position. The controller 170 may further perform the alignment movement to move the alignment stage 140 such that the position of the electrode 1 appearing in the second image Im2 is aligned with the reference positions RP1 and RP2.

The alignment movement is defined as transferring the electrode 1, positioned on the alignment stage 140 in a pre-moved state, to the reference positions RP1 and RP2 by transferring the alignment stage 140. When the alignment movement is performed, the vertical center line M1a and the horizontal center line M1b of the electrode 1 may be aligned with the reference positions RP1 and RP2, respectively. At this time, the center lines M2a and M2b of the alignment stage 140 may also be aligned with the reference positions RP1 and RP2. However, since there may be a slight difference between the center lines M2a and M2b of the alignment stage 140 and the center lines M1a and M1b of the electrode 1, the center lines M2a and M2b of the alignment stage 140 may slightly deviate from the reference positions RP1 and RP2 even when the center lines M1a and M1b of the electrode 1 are aligned with the reference positions RP1 and RP2. Nevertheless, since the electrode 1 is aligned with the reference positions RP1 and RP2, such a slight deviation of the center lines M2a and M2b of the alignment stage 140 from the reference positions RP1 and RP2 may not cause a problem.

After the first pickup device 131 picks up the electrode 1 from the electrode transfer part 110 and transfers it onto the alignment stage 140, the electrode transfer part 110 may transfer another electrode 1. During the execution of step S70 of obtaining the second image Im2 and step S80 of performing the alignment movement, the electrode transfer part 110 may transfer the electrode 1 to a predetermined position (see arrow B3), thereby reducing an overall time required for aligning the electrode 1.

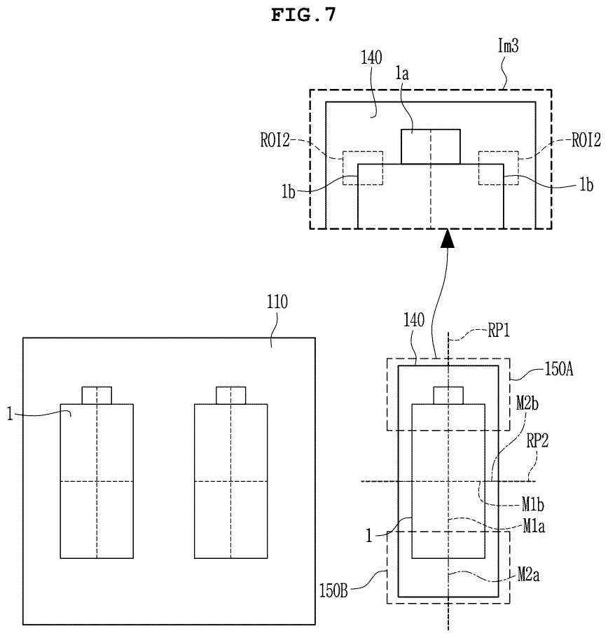

FIG. 7 illustrates a state in which an image of an electrode on the alignment-moved stage 140 is captured according to an embodiment of the present disclosure.

After the alignment movement is performed, the second imaging device 150 may perform step S90 of capturing an image of the electrode 1 on the alignment-moved alignment stage 140 to obtain a third image Im3. The second imaging device 150 may be configured to obtain a third image by capturing an image of the electrode seated on the pre-moved alignment stage.

The third image Im3 is an image of the electrode 1 on the alignment stage 140 after the alignment movement has been performed. In this alignment-moved state, the electrode 1 is in a position where its vertical center line M1a and horizontal center line M1b are aligned with the reference positions RP1 and RP2. The third image Im3 may be generated to determine whether the electrode 1 has been aligned with the reference positions RP1 and RP2 as a result of the alignment movement. The second imaging device 150 may generate the third image Im3 and provide it to the controller 170. The controller 170 may analyze the third image Im3 received from the second imaging device 150 to recognize the position of the electrode 1. The third image Im3 may be generated in the same manner as the second image Im2 is captured by the second imaging device 150, and the controller 170 may recognize the position of the electrode 1 from the third image Im3 in the same manner as from the second image Im2.

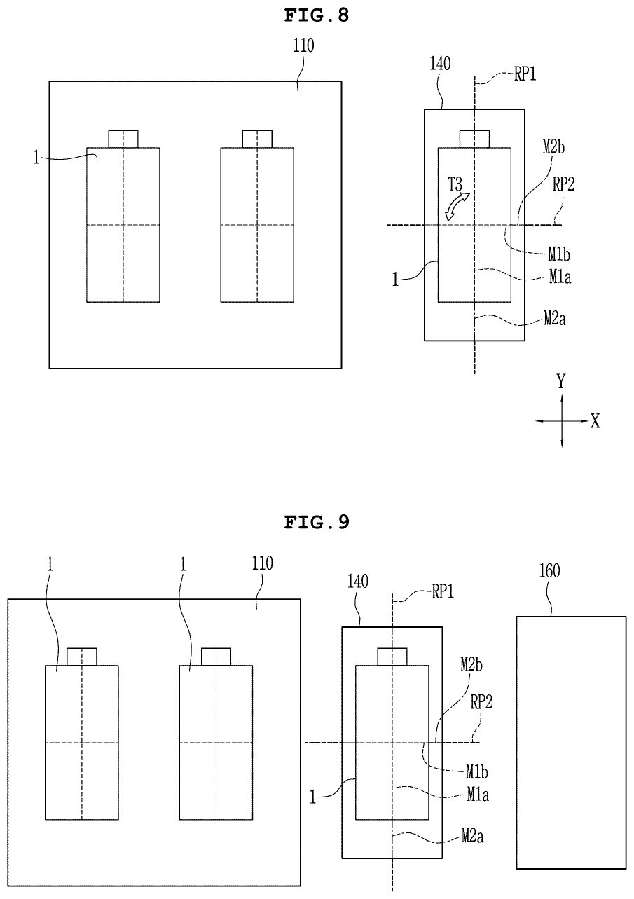

FIG. 8 illustrates a state in which the alignment stage 140 has been re-aligned according to an embodiment of the present disclosure.

When the controller 170 obtains the position of the electrode 1 on the alignment stage 140 and determines that a difference between the position of the electrode 1 and the reference positions RP1 and RP2 is smaller than a predetermined threshold, the controller 170 may omit performing a realignment movement.

When the controller 170 determines that the position of the electrode 1 on the alignment stage 140 does not match the reference positions RP1 and RP2, the controller 170 may perform step S100, in which the alignment stage 140 is moved to align the position of the electrode 1 shown in the third image Im3 with the reference positions RP1 and RP2. The controller 170 may further perform a realignment movement, in which the alignment stage 140 is moved such that the position of the electrode 1 shown in the third image Im3 is aligned with the reference positions RP1 and RP2.

The realignment movement is defined as transferring the electrode 1, which is in an alignment-moved state but not aligned with the reference positions RP1 and RP2, back to the reference positions RP1 and RP2 by transferring the alignment stage 140. When the electrode 1 is not aligned within a predetermined allowable range with respect to the reference positions RP1 and RP2, even after the alignment movement has been performed, the realignment movement may be additionally performed.

When the realignment movement is performed, the vertical center line M1a and horizontal center line M1b of the electrode 1 may be aligned with the reference positions RP1 and RP2. Since the realignment movement is performed to realign the electrode 1 that has already undergone the alignment movement, the movement distance is short and the movement time is brief.

After performing the realignment movement, the second imaging device 150 may capture an image of the electrode 1 on the alignment stage 140 again to obtain a fourth image (not shown). The controller 170 may then determine whether the position of the electrode 1 in the fourth image matches the reference positions RP1 and RP2. When the electrode 1 is determined not to be aligned with the reference positions RP1 and RP2, the controller 170 may control the second pickup device 132 or the third pickup device 133 to pick up the electrode 1 from the alignment stage 140 and transfer it to a storage location for defective electrodes.

Alternatively, when it is determined that the electrode 1 is not aligned with the reference positions RP1 and RP2, the controller 170 may perform the realignment movement again. The realignment movement may, however, be configured to be performed only a predetermined number of times. When the predetermined number of realignment movements has been performed and the electrode 1 is still determined not to be aligned with the reference positions RP1 and RP2, the controller 170 may pick up the electrode 1 from the alignment stage 140 and transfer it to the storage location for defective electrodes.

FIG. 9 illustrates a state in which the electrode 1 is aligned on the alignment stage 140, and no electrode is present in the stacker, according to an embodiment of the present disclosure.

When the controller 170 determines that the electrode 1 is aligned with the reference positions RP1 and RP2, the electrode 1 remains seated on the alignment stage 140, and no electrode 1 is present in the stacker.

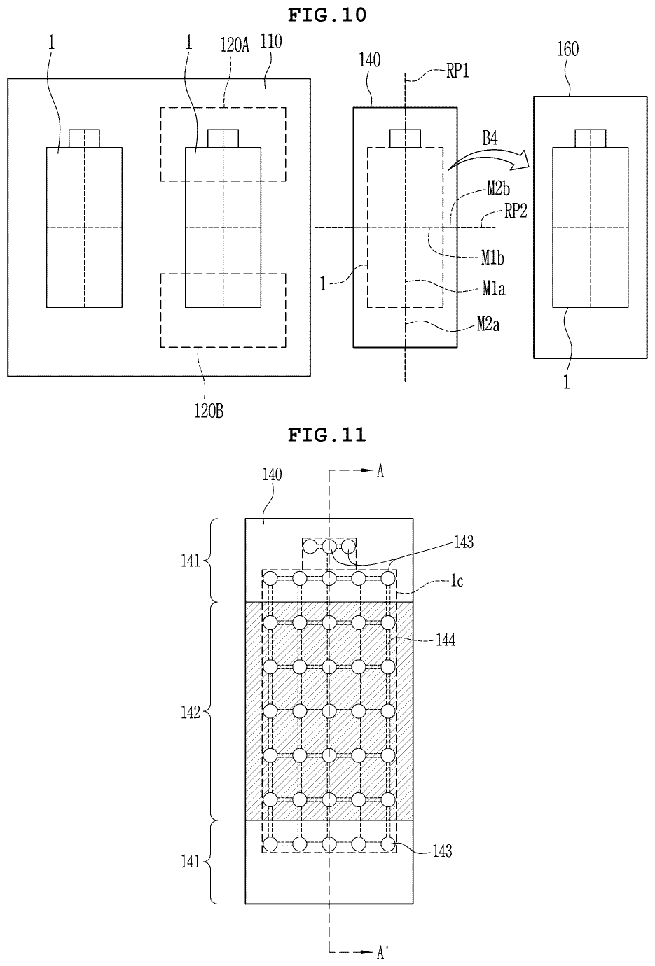

FIG. 10 illustrates a state in which the electrode 1 has been transferred from the alignment stage 140 to the stacker 160, according to an embodiment of the present disclosure.

The controller 170 may control the second pickup device 132 to pick up the electrode 1 from the alignment stage 140, move the picked-up electrode 1 to the stacker 160 (see arrow B4), and place the electrode 1 on the stacker 160. When the second pickup device 132 supplies the electrode 1 to the stacker 160, the stacker 160 may laminate an anode electrode 1p, a separator, and a cathode electrode 1n.

While the electrode 1 is being supplied to the stacker 160, the electrode transfer part 110 may be in a state where it has transferred an electrode 1 to a predetermined position. In addition, the first imaging device 120 may capture a first imaging region A 120A and a first imaging region B 120B of the electrode transfer part 110, and the controller 170 may perform a process of obtaining the position of the electrode 1 on the electrode transfer part 110. By performing, in parallel, step S20 of capturing the electrode 1 on the electrode transfer part 110 and the process of supplying the electrode 1 to the stacker 160, the overall time required for electrode alignment may be reduced.

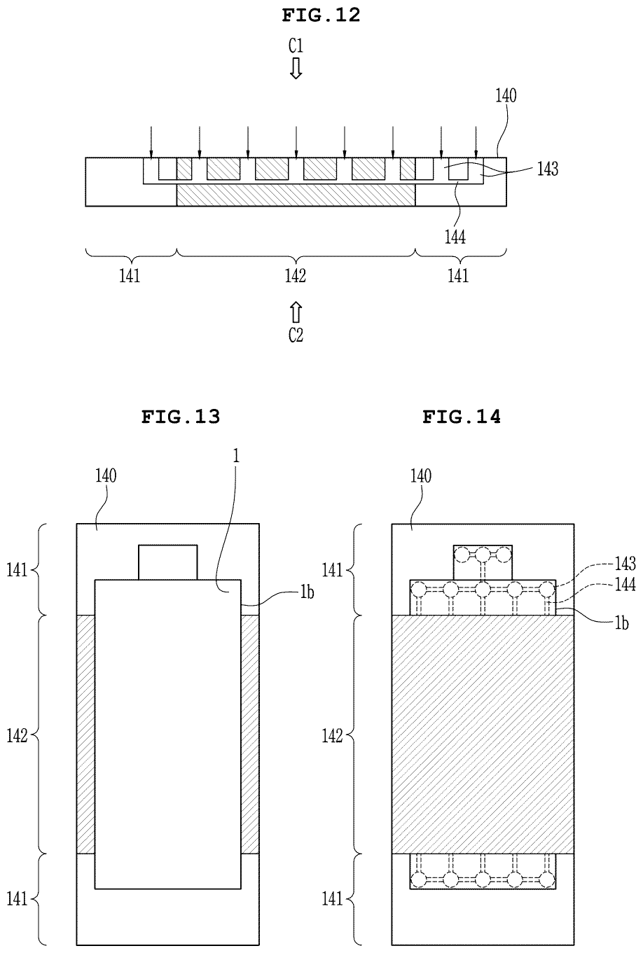

FIG. 11 illustrates a transparent region 141 and a fixing portion 143 of the alignment stage 140, according to an embodiment of the present disclosure, and FIG. 12 is a cross-sectional view taken along line A-A′ of FIG. 11, illustrating a second imaging device.

The alignment stage 140 may comprise an opaque region 142 made of an opaque material, and a transparent region 141 made of a transparent material to allow observation of an electrode seated on a top surface 140a from a bottom surface 140b.

The transparent region 141 may be formed to comprise a portion corresponding to the edge of the electrode 1 seated on the alignment stage 140. The transparent region 141 is provided to allow the second imaging device 150 to capture an image of the electrode 1 seated on the top surface 140a of the alignment stage 140 from a direction facing the bottom surface 140b of the alignment stage 140. The second imaging device 150 may capture an image of the electrode 1 through the transparent region 141, made of a transparent material, from the bottom surface 140b side of the alignment stage 140, opposite the top surface 140a on which the electrode 1 is seated.

The opaque region 142 may be located in a central portion of the alignment stage 140. The transparent region 141 may be located at any one end or at opposite ends of the alignment stage 140.

The second imaging device 150 may capture predetermined imaging regions 150A and 150B of the alignment stage 140 to measure the position of the electrode 1. The images of the imaging regions 150A and 150B captured by the second imaging device 150 may be regions including opposite end portions of the electrode 1. Specifically, an image of one end of the electrode 1, where a tab 1a is present, may be captured at the second imaging region A 150A, and an image of the opposite end of the electrode 1, where no tab 1a is present, may be captured at the second imaging region B 150B. Alternatively, images of regions corresponding to the vertices or edges of the electrode 1 may be captured at the imaging regions. Accordingly, the position and size of the transparent region 141 may be determined such that at least a portion of it overlaps with the imaging regions captured by the second imaging device 150.

When the boundary 1b of the electrode 1 appears in an image captured by the second imaging device 150 through the transparent region 141, the coordinates of the boundary 1b of the electrode 1 may be extracted, the position of the center line of the electrode 1 may be calculated, and then its position of the electrode 1 may be acquired.

FIG. 13 illustrates an electrode and the alignment stage, as viewed from C1 of FIG. 12, and FIG. 14 illustrates an electrode and the alignment stage, as viewed from C2 of FIG. 12.

Similar to the first imaging device 120 of FIG. 1, the second imaging device 150 may be located above the alignment stage 140, facing the top surface 140a of the alignment stage 140 on which the electrode 1 is seated. That is, the second imaging device 150 views the alignment stage 140 from direction C1 in FIG. 12. As shown in FIG. 13, since the electrode 1 is positioned on the alignment stage 140, it is not obscured from the second imaging device 150. Even though the alignment stage 140 is not transparent, when the second imaging device 150 captures an image of the electrode 1, the boundary 1b of the electrode 1 may appear in the image.

As shown in FIGS. 1 and 12, the second imaging device 150 may alternatively be located below the alignment stage 140, facing the bottom surface 140b of the alignment stage 140. That is, the second imaging device 150 views the alignment stage 140 from direction C2 in FIG. 12. In such a case, as shown in FIG. 14, a portion of the electrode 1 may be obscured by the opaque region 142 of the alignment stage 140. However, since the alignment stage 140 comprises the transparent region 141, the second imaging device 150 may capture an image of the electrode 1 through the transparent region 141.

FIGS. 11 through 14 are referenced again.

The alignment stage 140 may comprise a plurality of fixing portions 143 disposed along an edge 1b where the electrode 1 is to be seated and configured to fix the electrode 1. The fixing portions 143 may fix the electrode 1 seated on the alignment stage 140 thereto. The fixing portions 143 may comprise holding holes or holding pads for securing the electrode 1. The apparatus 100 for aligning an electrode may further comprise a negative pressure supply device (not shown) for generating a negative pressure in the fixing portions 143 of the alignment stage 140 to provide securing. Alternatively, the fixing portions 143 may comprise coils for securing the electrode 1 to the alignment stage 140 using magnetic force.

The alignment stage 140 according to an embodiment may further comprise an air line 144 for supplying negative pressure to the plurality of fixing portions 143. The air line 144 may comprise a conduit formed inside the alignment stage 140. The air line 144 may extend across both the opaque region 142 and the transparent region 141, and may be connected to the plurality of fixing portions 143. The air line 144 may be connected to a negative pressure supply device so as to transmit the negative pressure generated thereby to the fixing portions 143. The plurality of fixing portions 143 may fix the electrode 1 closely to the alignment stage 140 using the negative pressure supplied via the air line 144.

When the electrode 1 is seated on the alignment stage 140, the fixing portions 143 may operate to fix the electrode 1 to the alignment stage 140 at least temporarily. When the alignment stage 140 is moved with the fixing portions 143 operating, the electrode 1, fixed to the alignment stage 140, may move together with the alignment stage 140. Even when the alignment stage 140 is moved slightly, the electrode 1 may also be moved slightly, thereby allowing the electrode 1 to be accurately aligned with the reference position.

An electrode 1 seated on the alignment stage 140 may be subject to curling. The term “curling” refers to a condition in which a corner or an edge of the electrode 1 is curved upward or downward. The alignment stage 140 according to an embodiment may suppress both upward and downward curling.

The transparent regions 141 of the alignment stage 140 may support the four vertices and edges of the electrode 1, thereby preventing the electrode 1 from sagging downward relative to the lower side of the alignment stage 140. Thus, downward curling may not occur in the electrode 1 shown in the second image Im2 or the third image Im3.

The fixing portions 143 of the alignment stage 140 may secure the edge of the electrode 1, thereby bringing the edge of the electrode 1 into close contact with the alignment stage 140. Thus, upward curling may be prevented in the electrode 1 shown in the second image Im2 or the third image Im3.

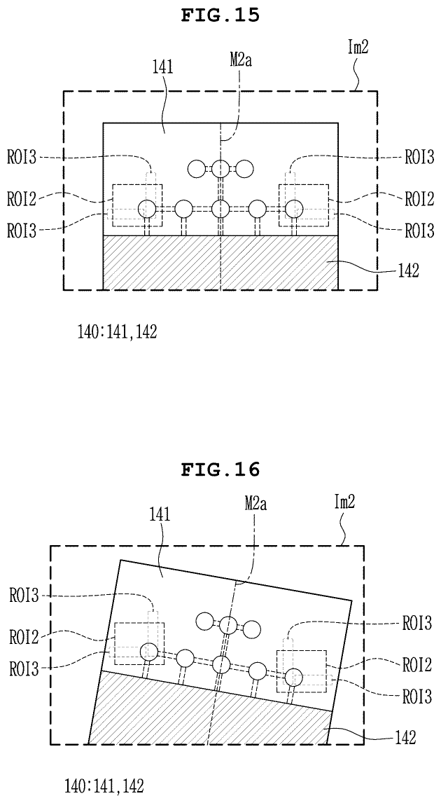

With reference to FIGS. 15 through 17, the movement of a second region of interest ROI2 in accordance with the movement of the alignment stage 140 according to an embodiment will be described. FIGS. 15 through 17 illustrate a case where the second imaging device 150 is positioned facing the bottom surface 140b of the alignment stage 140.

The controller 170 may move the region of interest ROI to detect the position of the electrode 1 in the second image Im2 in accordance with the movement of the alignment stage 140 shown in the second image Im2, and detect the position of the electrode 1.

FIG. 15 illustrates a position of a region of interest ROI in an image of the alignment stage 140 before pre-movement according to an embodiment of the present disclosure.

As shown in FIG. 2, FIG. 15 represents an image generated when the second imaging device 150 captures an image of the alignment stage 140 before pre-movement is performed. Although the second imaging device 150 does not actually capture the alignment stage 140 prior to pre-movement, FIG. 15 illustrates the second ROI2 in an image captured by the second imaging device 150 for the purpose of explaining the movement of the second ROI2.

Before the pre-movement is performed, the alignment stage 140 may be in a state in which the vertical center line M2a and the horizontal center line M2b are aligned with the reference positions RP1 and RP2. In this state, the second ROI2 may be set to a predetermined location in the image based on the position of the alignment stage 140. For example, the second ROI2 may be set to a location spaced apart by predetermined distances along the X-axis and Y-axis from a vertex of the alignment stage 140.

FIG. 16 illustrates a position of a region of interest ROI in an image of the alignment stage 140 after pre-movement according to an embodiment of the present disclosure.

As shown in FIG. 3, FIG. 16 represents an image generated when the second imaging device 150 captures the alignment stage 140 after the pre-movement is performed. Although the second imaging device 150 does not actually capture the alignment stage 140 after pre-movement, FIG. 16 illustrates the second ROI2 in an image captured by the second imaging device 150 for the purpose of explaining the movement of the second ROI2.

In the pre-moved state, the vertical center line M2a and the horizontal center line M2b of the alignment stage 140 may not be aligned with the reference positions RP1 and RP2, but instead may have moved to match the position of the electrode 1 on the electrode transfer part 110. In this state, since the position of the second imaging device 150 is fixed, the alignment stage 140 may appear to have been moved in the image captured by the second imaging device 150. The second ROI2 may be moved along the alignment stage 140. The controller 170 may move the second ROI2 in accordance with the movement of the alignment stage 140. For example, the position of the second ROI2 may be shifted from its originally set position by the same amount as the pre-movement performed by the alignment stage 140.

As shown in FIG. 3, when the alignment stage 140 rotates about the T-axis during pre-movement, the position of the second ROI2 may be shifted by the same amount of rotation as the alignment stage 140. However, this indicates that the position of the second ROI2 moves, but the second ROI2 itself is not rotated. The horizontal and vertical axes of the second ROI2 may remain parallel to those of the image.

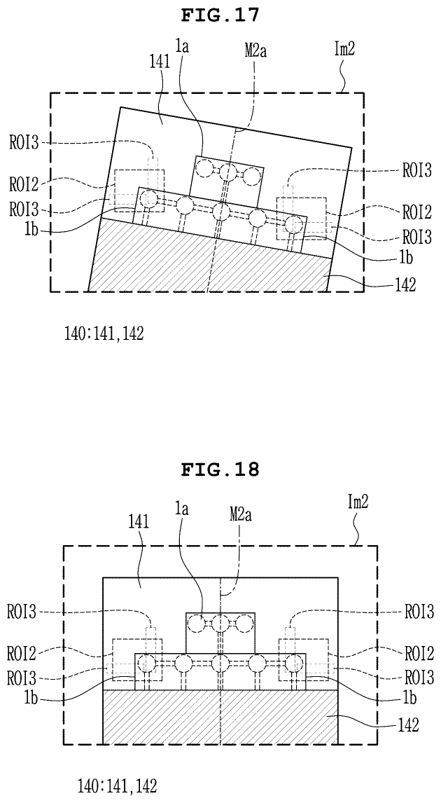

FIG. 17 illustrates a position of a region of interest ROI in an image of an electrode 1 seated on the alignment stage 140 after pre-movement according to an embodiment of the present disclosure.

FIG. 17 illustrates a second image Im2 generated when the second imaging device 150 captures an image of the electrode 1 seated on the alignment stage 140 after pre-movement, as shown in FIG. 5. The second imaging device 150 may capture the electrode 1 on the pre-moved alignment stage 140 to generate Im2 and provide it to the controller 170. The controller 170 may move the second region of interest ROI2 according to the position of the alignment stage 140 in Im2 and measure the position of the electrode 1. The second region of interest ROI2 may be an area within predetermined coordinates of the second image Im2. ROI2 may consist of multiple regions and may overlap. ROI2 is not an area displayed in Im2, but rather a region where the controller 170 performs image analysis to detect the boundary 1b of the electrode 1.

To determine the position of the second region of interest ROI2, the controller 170 may first detect the alignment stage 140 in the second image Im2. The controller 170 may detect a vertex of the alignment stage 140 or determine its position on the basis of a mark provided thereon.

Alternatively, the controller 170 may use the displacement or rotation applied to the alignment stage 140 during pre-movement to determine the position of ROI2.

The controller 170 may position the second region of interest ROI2 at a predetermined position relative to the alignment stage 140. For example, as described with reference to FIG. 16, when the alignment stage 140 rotates about the T-axis during pre-movement, ROI2 may move correspondingly with the rotation of the alignment stage 140.

Alternatively, the second region of interest ROI2 may be moved on the second image Im2 to a predetermined position with reference to the center lines M2a and M2b of the alignment stage 140. A plurality of second regions of interest ROI2 may be formed at predetermined positions relative to the center lines M2a and M2b of the alignment stage 140, and may move together when the alignment stage 140 moves.

Once the position of the second region of interest ROI2 is determined, the controller 170 may detect the boundary 1b of the electrode 1 using the second region of interest ROI2. Detecting the boundary 1b of the electrode 1 may be performed to obtain the position of the electrode 1 appearing in the second image Im2. For this purpose, the controller 170 may set ROI2 in the second image Im2 and detect the boundary 1b of the electrode 1 included within ROI2.

The controller 170 may further use a third region of interest ROI3 to detect the boundary 1b of the electrode 1. The third region of interest ROI3 may be located within the second region of interest ROI2. Accordingly, ROI3 may move together when ROI2 moves along with the alignment stage 140. When the boundary 1b of the electrode 1 is detected in ROI2, a plurality of ROI3s may be formed in areas corresponding to the boundary 1b within ROI2, thereby improving the accuracy of boundary detection.

The controller 170 may calculate the X-axis displacement, Y-axis displacement, and T-axis angular displacement of the electrode 1 relative to a reference position, on the basis of the coordinates of the detected boundary 1b obtained from the second and third regions of interest ROI2 and ROI3 and the horizontal and vertical dimensions of the electrode 1. The T-axis angular displacement may represent the degree of rotation of the electrode 1 relative to the reference position.

After accurately measuring the position of the electrode 1 on the alignment stage 140, the controller 170 may compare the position of the electrode 1 with a reference position and determine the deviation of the electrode 1 from the reference position. The controller 170 may then control the alignment stage 140 to align the electrode 1 with the reference position.

FIG. 18 illustrates a position of a region of interest ROI in an image of the electrode 1 on the alignment stage 140 after alignment movement, according to an embodiment of the present disclosure.

FIG. 18 shows a state in which the second imaging device 150 is positioned facing a bottom surface 140b of the alignment stage 140. FIG. 18 illustrates a third image Im3 generated when the second imaging device 150 captures an image of the electrode 1 on the alignment stage 140 after alignment movement, as shown in FIG. 7. The second imaging device 150 may generate the third image Im3 and provide it to the controller 170. The controller 170 may move the second region of interest ROI2 in accordance with the position of the alignment stage 140 appearing in the third image Im3, and measure the position of the electrode 1. As the alignment stage 140 moves during alignment, the controller 170 may move ROI2 in accordance with the movement of the alignment stage 140.

Details regarding the controller 170 obtaining the position of the alignment stage 140 to determine the position of the second region of interest ROI2 have been described with reference to FIG. 16, and redundant description is omitted.

Details regarding the controller 170 moving the second region of interest ROI2 in accordance with the movement of the alignment stage 140 and detecting the boundary 1b of the electrode 1 using the third region of interest ROI3 are also described with reference to FIG. 16, and redundant description is omitted.

When the alignment stage 140 rotates in a direction opposite to the pre-movement during alignment movement, the position of the second region of interest ROI2 may be adjusted according to the rotation of the alignment stage 140. Once the position of ROI2 is determined, the controller 170 may detect the boundary 1b of the electrode 1 using ROI2, form a third region of interest ROI3 within ROI2, and more accurately detect the boundary 1b of the electrode 1.

The controller 170 may determine whether the electrode 1 is aligned to the reference position using the coordinates of the boundary 1b detected from the second and third regions of interest ROI2 and ROI3 and the dimensions of the electrode 1.

The method by which the controller 170 obtains the position of the electrode 1 from the first image Im1 in FIG. 2 using a first region of interest ROI1 is also substantially similar to the method of obtaining the position of the electrode 1 from the second image Im2 described above.

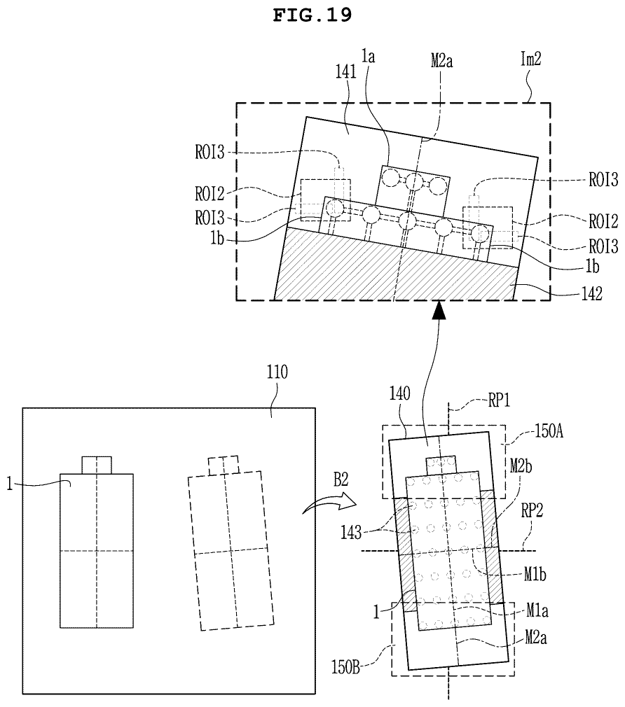

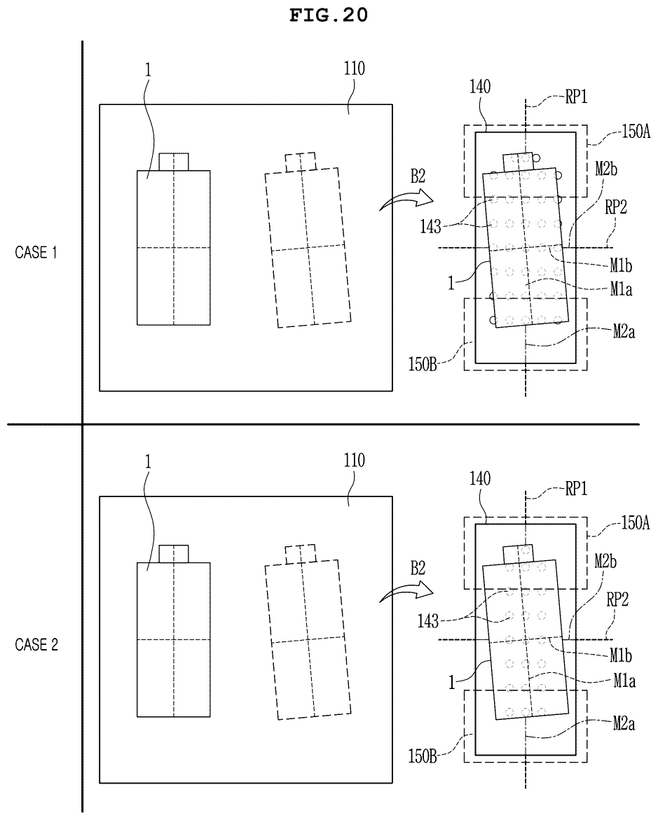

FIG. 19 illustrates the function of the fixing portion 143 according to an embodiment of the present disclosure, and FIG. 20 illustrates a relationship between the position of the fixing portion 143 and the electrode 1 in a comparative example. FIGS. 19 and 20 are referred to together and are shown with reference to a state in which the second imaging device 150 is positioned toward the bottom surface 140b of the alignment stage 140.

The fixing portion 143 formed on the alignment stage 140 may be positioned within the area where the electrode 1 is to be seated. The fixing portion 143 may be positioned adjacent to an edge 1c of the area in which the electrode 1 is to be seated. The edge 1c may refer to a line connecting the outer boundary enclosing the main body and the tab 1a of the electrode 1. The fixing portion 143 may be positioned adjacent to the vertices of the electrode 1 and the tab 1a. When the fixing portion 143 operates, the vertices of the electrode 1 and the tab 1a may be brought into close contact with the top surface 140a of the alignment stage 140, thereby preventing a curling phenomenon that may occur at the vertices or edges. The curling condition in which the vertices or edges of the electrode 1 or the tab 1a are spaced apart from and curved relative to the top surface 140a of the alignment stage 140. When curling occurs, the boundary 1b of the electrode 1 in the second image Im2 captured by the second imaging device 150 may appear displaced from the actual position. Therefore, it may be difficult to accurately obtain the position of an electrode 1 exhibiting curling from the second image Im2.

When the fixing portion 143 is positioned away from the edge 1c of the electrode 1, curling may occur at the edge even when the fixing portion 143 secures the electrode 1. However, according to an embodiment, since the fixing portion 143 is installed adjacent to the edge 1c where the electrode 1 is seated, the edge of the electrode 1 may be secured, thereby preventing curl formation. Consequently, an image of the electrode 1 captured in the second image Im2 does not exhibit curling, allowing reliable detection of the position of the electrode.

The fixing portion 143 may be formed adjacent to the edge 1c of the area where the electrode 1 is seated in an embodiment, since the alignment stage 140 has undergone pre-movement.

When the alignment stage 140 performs pre-movement T1, it may move in correspondence with the position of the electrode 1 on the electrode transfer device 110. Thus, the electrode 1 transferred onto the alignment stage 140 may be consistently seated at substantially the same position. Accordingly, as illustrated in FIG. 16, the electrode 1 is transferred to the pre-moved alignment stage 140 so as to cover all fixing portions 143. The electrode 1 may be seated on the alignment stage 140 so as to cover all fixing portions 143, as shown in FIG. 13. In this state, when the second imaging device 150 captures the second image Im2, the fixing portions 143 may not appear outside the boundary 1b of the electrode 1. Accordingly, in the process of detecting the boundary 1b of the electrode 1 using the second region of interest ROI2, false detection of the fixing portions 143 as the boundary 1b of the electrode 1 may be avoided.

By contrast, CASE 1 of FIG. 20 illustrates a comparative example in which the fixing portion 143 is positioned adjacent to the edge 1c of the area where the electrode 1 is seated, but pre-movement is not performed. Even though the fixing portion 143 is installed adjacent to the edge 1c, when the electrode 1 seated on the alignment stage 140 deviates from the reference positions RP1 and RP2, the fixing portion 143 may be positioned outside the boundary 1b of the electrode 1. That is, the electrode 1 may not completely cover all of the fixing portions 143. In this state, when the second imaging device 150 captures the second image Im2 or the third image Im3, the fixing portions 143 may appear outside the boundary 1b of the electrode 1. When this occurs, the second region of interest ROI2 or the third region of interest ROI3, described with reference to FIG. 17, may erroneously recognize the fixing portions 143 as the boundary 1b of the electrode 1 in the process of detecting the boundary 1b of the electrode 1.

Thus, even when the fixing portion 143 is formed adjacent to the edge 1c of the area where the electrode 1 is seated, pre-movement is required to be performed in order to prevent curl formation and avoid misdetection of the electrode boundary 1b.

Meanwhile, unlike CASE 1, CASE 2 illustrates a comparative example in which the fixing portion 143 is positioned away from the edge 1c to prevent it from appearing outside the electrode boundary 1b. In this case, even when the electrode 1, deviating from the reference positions RP1 and RP2, is seated on the alignment stage 140, the electrode 1 may cover the entire fixing portion 143 but not the edge 1c, thereby allowing curl formation at the edges. Consequently, the electrode 1 in the image may exhibit curling, making accurate detection of the position of the electrode difficult.

Both CASE 1 and CASE 2 present problems arising from the lack of pre-movement of the alignment stage 140. In contrast, according to an embodiment, because pre-movement is performed before the electrode 1 is seated on the alignment stage 140, all fixing portions 143 may be positioned within the boundary 1b, even when they are adjacent to the edges 1c of the seating area. Any deviation in the position of the electrode during transfer onto the alignment stage 140 may be minimized because the alignment stage 140 moves in accordance with the position of the electrode during pre-movement.

Therefore, the electrode 1 may be seated at substantially the same position each time, allowing the four vertices of the electrode 1 to be consistently secured by the fixing portions 143 and thereby preventing curl formation. Accordingly, the electrode 1 captured in the second image Im2 does not exhibit curl formation, which enables accurate detection of the electrode position.

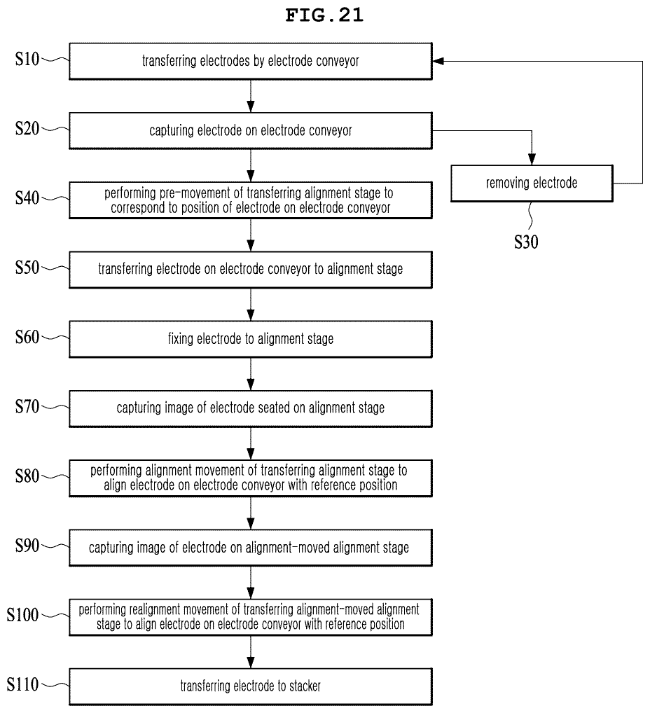

FIG. 21 illustrates an electrode alignment method according to an embodiment of the present disclosure.

According to an embodiment, the electrode alignment method may comprise: step S10 of transferring a plurality of electrodes 1 using an electrode transfer device 110; step S20 of obtaining a first image using a first imaging device 120 that captures an image of an electrode 1 on the electrode transfer device 110; step S40 of performing a pre-movement by transferring an alignment stage 140 with a controller 170 to correspond to the position of the electrode 1 in the first image Im1; and step S50 of transferring the electrode 1 from the electrode transfer device 110 to the alignment stage 140 using a first pickup device 131.

As shown in FIG. 2, step S10 of transferring the electrodes 1 may comprise transferring the electrodes 1 to a predetermined position. The electrode transfer device 110 may receive the electrodes 1 from an electrode manufacturing device, an electrode supply device, or a magazine, and transfer them toward the alignment stage 140. The electrode transfer device 110 may repeatedly move and stop the electrodes 1 at the predetermined position.

As shown in FIGS. 1 and 2, step S20 of obtaining the first image Im1 may comprise capturing an image of the electrodes 1 on the electrode transfer device 110 using the first imaging device 120, generating the first image Im1, and providing the first image Im1 to the controller 170. Two first imaging devices 120 may respectively generate two first images Im1 by capturing images of portions of the electrodes 1 with and without tabs 1a, and provide the images to the controller 170.

The controller 170 may detect the boundaries 1b of the electrodes 1 from the received first image Im1 and obtain the positions of the electrodes 1. The controller 170 may calculate the vertical and horizontal centerlines M1a and M1b of the electrodes 1 and determine the degree of deviation of the electrodes 1 from the reference positions RP1 and RP2. Specifically, the controller 170 may calculate the deviations along the X-axis and Y-axis, as well as the rotational deviation along the T-axis.

According to an embodiment, the electrode alignment method may further comprise step S30 of determining that an electrode is defective and generating a removal command in response to the controller 170 determining that the position of the electrode 1 on the electrode transfer device 110 exceeds a preset alignable range relative to the reference position. As described with reference to FIG. 1, when the electrodes 1 on the electrode transfer device 110 deviate significantly from the reference positions RP1 and RP2, the controller 170 may determine that the time required for alignment is excessive or that alignment is not possible, and may thus determine the electrodes 1 to be defective and remove them from the process line. The controller 170 may control the pickup devices 131, 132, and 133 and the electrode transfer device 110 to pick up the defective electrodes 1 and transfer them to a defective discharge location.

As shown in FIG. 3, step S40 of performing pre-movement may comprise transferring the alignment stage 140 by the controller 170 to correspond to the positions of the electrodes 1.

The controller 170 may move the alignment stage 140 along the X-axis and Y-axis according to the deviations of the electrodes 1 and rotate the alignment stage 140 by a deviation angle along the T-axis, thereby performing the pre-movement.

As shown in FIG. 4, step S50 of transferring the electrodes 1 to the alignment stage 140 may comprise controlling the first pickup device 131 by the controller 170 to transfer the electrodes 1 from the electrode transfer device 110 to the alignment stage 140. The controller 170 may control the first pickup device 131 to transfer the electrodes 1 directly without correcting their deviations. Since the alignment stage 140 has been pre-moved, the centerlines M1a and M1b of the electrodes 1 and the centerlines M2a and M2b of the alignment stage 140 may substantially coincide.

As shown in FIG. 19, the electrode alignment method according to an embodiment may further comprise step S60 of fixing the electrodes 1 seated on the alignment stage 140 using a plurality of fixing members 143 disposed along the edges of the alignment stage where the electrodes 1 are seated. In step S60 of fixing the electrodes 1, the controller 170 may control the fixing members 143 to hold the electrodes 1 on the alignment stage 140, thereby securing the electrodes in place. Because the fixing members 143 are formed adjacent to the edges of the electrodes 1, curling at the edges may be prevented. Since the electrodes 1 are transferred to the alignment stage 140 in a pre-moved state, the electrodes 1 may be seated so as to cover all the fixing members 143.

As shown in FIG. 5, the electrode alignment method according to an embodiment may further comprise step S70 of obtaining a second image Im2 by a second imaging device 150 that captures an image of the electrodes 1 seated on the pre-moved alignment stage 140. In step S70 of obtaining the second image Im2, the controller 170 may control the second imaging device 150 to perform the image capturing.

Here, the alignment stage 140 may comprise an opaque region 142 made of an opaque material and a transparent region 141 made of a transparent material to allow observation of an electrode seated on its top surface 140a from its bottom surface 140b.

In addition, step S70 of obtaining the second image Im2 may comprise capturing, by the second imaging device 150, an image of the electrode 1 through the transparent region 141 in the direction of the bottom surface 140b, which is opposite to the top surface 140a on which the electrode 1 of the alignment stage 140 is seated. As described with reference to FIG. 11, the alignment stage 140 may comprise both opaque and transparent regions. As described with reference to FIG. 12, the second imaging device 150 may be positioned beneath the alignment stage 140 to capture an image of the electrodes 1 through the transparent region 141, thereby generating the second image Im2.

The electrode alignment method may further comprise step S80 of performing an alignment movement in which the controller 170 moves the alignment stage 140 to align the positions of the electrodes 1 shown in the second image Im2 with the reference positions RP1 and RP2.

Step S80 of performing an alignment movement may comprise performing the alignment movement such that the controller 170 moves the region of interest (that is, the second region of interest ROI2) in accordance with the movement of the alignment stage 140 to detect the position of the electrode 1 shown in the second image Im2, determines the position of the electrode 1, and moves the alignment stage 140 such that the position of the electrode 1 shown in the second image Im2 is aligned with the reference positions RP1 and RP2.

The controller 170 may move the region of interest according to the movement of the alignment stage 140 to detect the positions of the electrodes 1 in the second image Im2. As described with reference to FIGS. 16 and 17, the controller 170 may move the second region of interest ROI2 in response to the movement of the alignment stage 140. Therefore, when detecting the positions of the electrodes 1 in the second image Im2, it is easier to detect the boundaries 1b of the electrodes 1, since specific portions of the electrodes 1 are always located within the second region of interest ROI2.

After obtaining the positions of the electrodes 1 in the second image Im2, the controller 170 may perform the alignment movement. As described with reference to FIG. 6, the controller 170 may move the alignment stage 140 to align the electrodes 1 on the alignment stage 140 with the reference positions RP1 and RP2. The alignment movement may comprise at least one of an X-axis movement, a Y-axis movement, or a T-axis rotation.

The electrode alignment method may further comprise step S90 of obtaining by the second imaging device 150, a third image Im3 by capturing an image of the electrode 1 on the alignment stage 140 that has been alignment-moved. As described with reference to FIG. 7, step S90 of obtaining the third image Im3 may be performed after the alignment movement to verify whether the electrodes 1 are aligned with the reference positions RP1 and RP2.

As described with reference to FIG. 18, the second imaging device 150 may capture an image of the electrodes 1 on the alignment stage 140 after the alignment movement to generate the third image Im3 and provide the image to the controller 170.

The electrode alignment method may further comprise step S100 of performing a re-alignment movement, by the controller 170, to move the alignment stage 140 such that the position of the electrode 1 shown in the third image Im3 is aligned with the reference position. As described with reference to FIG. 8, the re-alignment movement may be performed when the electrodes 1 are not aligned with the reference positions RP1 and RP2 after the alignment movement.

The re-alignment movement may comprise movement of the alignment stage 140 along the X-axis, Y-axis, or T-axis. When the third image Im3 indicates that the electrodes 1 are already aligned with the reference positions after the alignment movement, the re-alignment movement may not be performed.

When the electrodes 1 on the alignment stage 140 are aligned with the reference positions RP1 and RP2, the electrode alignment method may further comprise step S110 of transferring the electrodes 1 to a stacker 160 using a second pickup device 132. As shown in FIGS. 9 and 10, when the controller 170 determines that the electrodes 1 on the alignment stage 140 are aligned with the reference positions RP1 and RP2, the controller 170 may control the second pickup device 132 to transfer the electrodes 1 to the stacker 160. The stacker 160 may use the transferred electrodes 1 to assemble a laminate comprising a positive electrode 1p, a separator, and a negative electrode 1n.

The apparatus 100 for aligning and the method described above may quickly and accurately align the electrodes 1 to the reference positions to supply them to the stacker 160.

The above description has been provided with reference to specific exemplary embodiments. The foregoing description is merely illustrative of the principles of the present disclosure, and various modifications and alternative arrangements may be made without departing from the scope of the invention.

What is claimed is:

1. An apparatus for aligning an electrode, the apparatus comprising:
an electrode transfer device configured to transfer a plurality of electrodes;
a first imaging device configured to obtain a first image by capturing an image of the electrode on the electrode transfer device;
an alignment stage having a top surface on which the electrode transferred from the electrode transfer device is seated, the alignment stage being movable;
a first pickup device configured to transfer the electrode from the electrode transfer device to the alignment stage; and
a controller configured to perform a pre-movement of the alignment stage such that the alignment stage corresponds to a position of the electrode shown in the first image before the electrode is seated on the alignment stage.

2. The apparatus of claim 1, wherein, when the position of the electrode shown in the first image exceeds a preset alignable range relative to a reference position, the controller may determine that the electrode is defective and generate a removal command.

3. The apparatus of claim 1, further comprising a second imaging device configured to obtain a second image by capturing the image of the electrode seated on a pre-moved alignment stage,
wherein the controller performs an alignment movement to transfer the alignment stage such that the position of the electrode shown in the second image is aligned with the reference position.

4. The apparatus of claim 3, wherein the second imaging device is configured to obtain a third image by capturing the image of the electrode seated on the pre-moved alignment stage, and
the controller may further perform the alignment movement to transfer the alignment stage such that the position of the electrode shown in the third image is aligned with the reference position.

5. The apparatus of claim 3, wherein the alignment stage comprises:
an opaque region made of an opaque material; and
a transparent region made of a transparent material to allow observation of the electrode seated on the top surface from a bottom surface,
wherein the second imaging device may capture the image of the electrode through the transparent region in the direction from the bottom surface, opposite to the top surface on which the electrode of the alignment stage is seated.

6. The apparatus of claim 3, wherein the controller may move a region of interest for detecting the position of the electrode in the second image according to a movement of the alignment stage shown in the second image in accordance with the movement of the alignment stage and detect the position of the electrode.

7. The apparatus of claims 1, wherein the alignment stage may comprise a plurality of fixing portions disposed along an edge where the electrode is to be seated and configured to secure the electrode.

8. A method for aligning an electrode, the method comprising:
transferring a plurality of electrodes using an electrode transfer device;
obtaining a first image using a first imaging device that captures an image of the electrode on the electrode transfer device;
performing a pre-movement by transferring an alignment stage with a controller to correspond to a position of the electrode in the first image; and
transferring the electrode from the electrode transfer device to the alignment stage using a first pickup device.

9. The method of claim 8, further comprising:
determining that the electrode is defective and generating a removal command in response to the controller determining that the position of the electrode on the electrode transfer device exceeds a preset alignable range relative to a reference position.

10. The method of claim 8, further comprising:
obtaining, by a second imaging device, a second image by capturing the image of the electrode seated on a pre-moved alignment stage; and
performing an alignment movement to transfer the alignment stage, by the controller, such that the position of the electrode shown in the second image is aligned with the reference position.

11. The method of claim 10, further comprising:
obtaining, by the second imaging device, a third image by capturing the image of the electrode on the alignment stage that has been alignment-moved; and
performing a realignment movement, by the controller, to transfer the alignment stage such that the position of the electrode shown in the third image is aligned with the reference position.

12. The method of claim 10, wherein the alignment stage comprises:
an opaque region made of an opaque material; and
a transparent region made of a transparent material to allow observation of the electrode seated on a top surface from a bottom surface,
wherein the obtaining the second image may comprise capturing, by the second imaging device, the image of the electrode through the transparent region in the direction from the bottom surface, opposite to the top surface on which the electrode of the alignment stage is seated.

13. The method of claim 10, wherein the performing the alignment movement may comprise performing the alignment movement such that the controller moves a region of interest in accordance with a movement of the alignment stage to detect the position of the electrode shown in the second image, determines the position of the electrode, and transfers the alignment stage such that the position of the electrode shown in the second image is aligned with the reference position.

14. The method of claims 8, further comprising:
fixing the electrode seated on the alignment stage using a plurality of fixing portions disposed along an edge of the alignment stage where the electrode is seated.
